(19) United States
(12) Patent Application Publication
(10) Pub. No.: US 2025/0306494 A1
(43) Pub. Date: Oct. 2, 2025

(54) POWDER SUPPLY DEVICE AND POWDER PROCESSING SYSTEM USING POWDER SUPPLY DEVICE

(71) Applicant: FUJIFILM Business Innovation Corp., Tokyo (JP)

(72) Inventors: Satoshi TEJIMA, Kanagawa (JP); Fuyuki KOKUBU, Kanagawa (JP)

(73) Assignee: FUJIFILM Business Innovation Corp., Tokyo (JP)

(21) Appl. No.: 18/822,286

(22) Filed: Sep. 2, 2024

(30) Foreign Application Priority Data
Mar. 28, 2024 (JP) 2024-054834

(51) Int. Cl. G03G 15/01; G03G 15/08

(52) U.S. Cl. CPC G03G 15/0121; G03G 15/0189; G03G 15/0891

(57) ABSTRACT

A powder supply device includes: plural supply sections that are provided respectively for plural processing subjects arranged in a processing order of plural colors at a predetermined interval and that supply powder divided into plural color components to each processing subject; plural accommodation sections that are arranged at an interval wider than an arrangement interval between the plural processing subjects and that accommodate the powder divided into the plural color components; and plural transport sections that are respectively connected in communication between the plural accommodation sections and the plural supply sections and that transport the powder of each color component accommodated in each accommodation section to each supply section, in which the plural transport sections have a configuration that is shareable at least for the processing subjects of which the processing order is changeable.

### CROSS-REFERENCE TO RELATED APPLICATIONS

This application is based on and claims priority under 35 USC 119 from Japanese Patent Application No. 2024-054834 filed Mar. 28, 2024.

### BACKGROUND

### (i) Technical Field

The present invention relates to a powder supply device and a powder processing system using the powder supply device.

### (ii) Related Art

As a powder supply device in the related art or a powder processing system using the powder supply device, for example, JP2019-152810A (Mode for Carrying Out the Invention and FIG. 8) and JP2018-197766A (Mode for Carrying Out the Invention and FIG. 5) are already known.

JP2019-152810A (Mode for Carrying Out the Invention and FIG. 8) discloses a developer replenishing device that replenishes one of a plurality of replenished portions having different dispositions with a developer accommodated in a developer container, the developer replenishing device including a plurality of transport paths that are formed to be connectable to the plurality of replenished portions, in which a transport path corresponding to one replenished portion among the plurality of transport paths is connected to the one replenished portion, the other transport paths are not connected to any replenished portion, and the dispositions of the plurality of replenished portions can be relatively easily changed.

JP2018-197766A (Mode for Carrying Out the Invention and FIG. 5) discloses an image forming device that changes an arrangement of a plurality of developing devices in a traveling direction without changing an arrangement of a plurality of developer containers, and changes a layout of the plurality of transport paths without changing a relationship between a replenish source and a replenish destination of the plurality of transport paths, thereby relatively easily changing the arrangement of the plurality of developing devices to an order of toner colors layered on a surface of an intermediate transfer body.

### SUMMARY

Aspects of non-limiting embodiments of the present disclosure relate to a powder supply device and a powder processing system using the powder supply device with which, in an aspect in which accommodation sections for powder of a plurality of color components are arranged at an interval wider than an arrangement interval between processing subjects arranged in a processing order of a plurality of colors, in a case in which the processing order between the processing subjects is changed, a change in a component that supplies the powder to the processing subjects of which the processing order is changeable is minimized, and sharing of the component is realized.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a powder supply device including: a plurality of supply sections that are provided respectively for of a plurality of processing subjects arranged in a processing order of a plurality of colors at a predetermined interval and that supply powder divided into a plurality of color components to each processing subject; a plurality of accommodation sections that are arranged at an interval wider than an arrangement interval between the plurality of processing subjects and that accommodate the powder divided into the plurality of color components; and a plurality of transport sections that are respectively connected in communication between the plurality of accommodation sections and the plurality of supply sections and that transport the powder of each color component accommodated in each accommodation section to each supply section, in which the plurality of transport sections have a configuration that is shareable at least for the processing subjects of which the processing order is changeable.

### BRIEF DESCRIPTION OF THE DRAWINGS

Exemplary embodiment(s) of the present invention will be described in detail based on the following figures, wherein:

FIG. 1A is an explanatory diagram showing an outline of an exemplary embodiment of a powder processing system including a powder supply device to which the present invention is applied, FIG. 1B is a plan view of FIG. 1A seen from above, and FIG. 1C is an explanatory diagram showing an application example of the powder supply device in a case in which a processing order is changed between a processing subject in a most upstream color and a processing subject in a most downstream color;

FIG. 2 is an explanatory diagram showing an overall configuration of an image forming system as the powder processing system according to Exemplary Embodiment 1;

FIG. 3 is an explanatory diagram showing a basic configuration of a toner supply system of the image forming system according to Exemplary Embodiment 1;

FIG. 4 is an explanatory diagram showing an example of an attachment device of a toner cartridge of the toner supply system according to Exemplary Embodiment 1;

FIG. 5A is an explanatory diagram showing an example of a transport path component as a transport section that connects the toner cartridge of the toner supply system and A developing device, and FIG. 5B is an explanatory diagram showing a positional relationship between the toner cartridge, the transport path component, and the developing device;

FIG. 6A is an explanatory diagram showing an example of the transport path component used in the present exemplary embodiment, FIG. 6B is an explanatory diagram showing an aspect in which the transport path component shown in FIG. 6A is made of an elastic pipe, and FIG. 6C is an explanatory diagram showing an aspect in which the transport path component shown in FIG. 6A has an expansion and contraction portion;

FIG. 7 is an explanatory diagram schematically showing an arrangement relationship between a plurality of image forming portions of each color component and each toner cartridge including a container that accommodates each color toner in the image forming system according to Exemplary Embodiment 1;

FIG. 8 is a plan explanatory diagram in which the toner cartridge of each color is omitted from FIG. 7;

FIG. 9 is an explanatory diagram showing a configuration example of the transport path component in a case in which the processing order between the image forming portion of the most upstream color and the image forming portion of the most downstream color is changed;

FIG. 10A is an explanatory diagram showing an arrangement of the image forming portion in which the most upstream color is white and the image forming portion in which the most downstream color is black, FIG. 10B is an explanatory diagram schematically showing, in the arrangement of the image forming portions shown in FIG. 10A, an overlapping state between a white image portion and a colored image portion on an intermediate transfer body, and an overlapping state between the white image portion and the colored image portion on a medium, FIG. 10C is an explanatory diagram showing an arrangement of the image forming portion in which the most upstream color is black and the image forming portion in which the most downstream color is white, and FIG. 10D is an explanatory diagram schematically showing, in the arrangement of the image forming portions shown in FIG. 10C, an overlapping state between a white image portion and a colored image portion on an intermediate transfer body, and an overlapping state between the white image portion and the colored image portion on a medium;

FIG. 11 is an explanatory diagram showing an example of a cooling structure around the transport path component of each color in the present exemplary embodiment;

FIG. 12 is an explanatory diagram showing an example of a toner supply system of an image forming system according to Comparative Example 1;

FIG. 13 is an explanatory diagram showing a layout of a toner supply system of an image forming system according to Modification Example 1;

FIG. 14 is an explanatory diagram showing a configuration example of the transport path component in a case in which the processing order between the image forming portion of the most upstream color and the image forming portion of the most downstream color is changed in the image forming system according to Modification Example 1; and

FIG. 15 is an explanatory diagram showing a layout of a toner supply system of an image forming system according to Modification Example 2.

### DETAILED DESCRIPTION

### Outline of Exemplary Embodiment

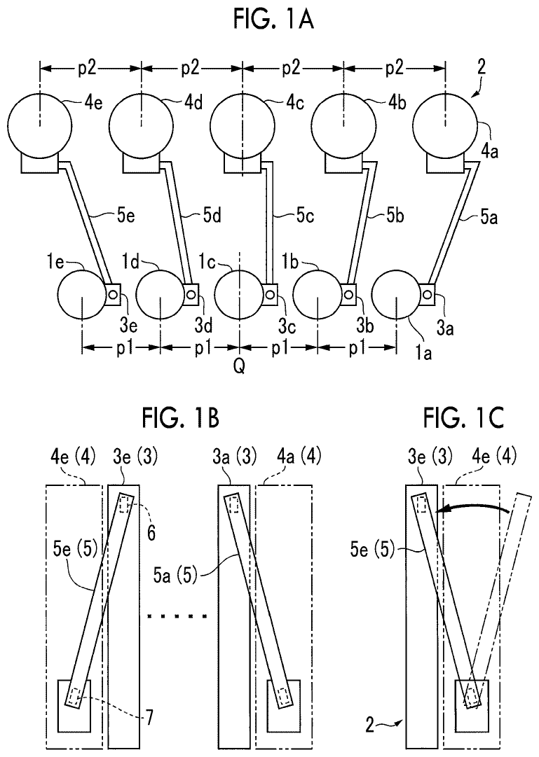

FIG. 1A shows an outline of an exemplary embodiment of a powder processing system using a powder supply device to which the present invention is applied.

In FIG. 1A, the powder processing system includes a plurality of processing subjects 1 (for example, 1a to 1e) arranged in a processing order of a plurality of colors at a predetermined interval, and a plurality of powder supply devices 2 (for example, 2a to 2e) that supply powder of a plurality of color components to the plurality of processing subjects 1.

In the present example, the powder supply device 2 (2a to 2e) includes, as shown in FIGS. 1A and 1B, a plurality of supply sections 3 (for example, 3a to 3e) that are provided respectively for of the plurality of processing subjects 1 (1a to 1e) arranged in the processing order of the plurality of colors at a predetermined interval p1 and that supply the powder divided into the plurality of color components to each processing subject 1 (1a to 1e), a plurality of accommodation sections 4 (for example, 4a to 4e) that are arranged at an interval p2 wider than an arrangement interval p1 between the plurality of processing subjects 1 and that accommodate the powder divided into the plurality of color components, and a plurality of transport sections 5 (for example, 5a to 5e) that are respectively connected in communication between the plurality of accommodation sections 4 (4a to 4e) and the plurality of supply sections 3 (3a to 3e) and that transport the powder of each color component accommodated in each accommodation section 4 (4a to 4e) to each supply section 3 (3a to 3e), in which the plurality of transport sections 5 (for example, 5a to 5e) have a configuration that is shareable at least for the processing subjects 1 of which the processing order is changeable.

In FIG. 1B, reference numeral 6 indicates a connection port between the supply section 3 and the transport section 5, and reference numeral 7 indicates a connection port between the accommodation section 4 and the transport section 5.

In such technical means, the “powder processing system” in the present example broadly includes a system that supplies the powder to the processing subject 1 and performs processing using the powder. An image forming system is a typical example as the powder processing system. In this case, in the image forming system, the powder is an imaging material, the powder supply device 2 includes a developing section as the supply section 3 that develops the imaging material, the accommodation section 4 that accommodates the imaging material, and a transport section as the transport section 5 that transports the imaging material, and the processing subject 1 is an image holding section that holds an image produced by the imaging material. The image holding section referred to herein refers to, for example, a part of the image forming portion, such as a photoconductor or a dielectric.

However, the powder processing system is not limited to the image forming system described above and can also be applied to a powder spray system that sprays the powder onto the processing subject 1, a powder application system that applies the powder, or the like.

The present example is premised on an aspect in which the arrangement interval p2 between the plurality of accommodation sections 4 is wider than the arrangement interval p1 between the plurality of processing subjects 1. This is intended to increase the powder accommodation capacity of the plurality of accommodation sections 4 and to extend the supply time of the powder to the processing subject 1.

In the present example, the plurality of colors may be appropriately selected, and may include, for example, four colors of cyan, magenta, yellow, and black, or include a spot color in addition to the four colors described above. Examples of the “spot color” include clear or white, but the “spot color” is not limited to this and also includes special colors such as gold and silver, as well as corporate image colors.

Further, the processing subject 1 is not limited to being in a horizontal arrangement and may be in a vertical arrangement. Here, in a case in which the processing subject 1 is in the horizontal arrangement, the plurality of accommodation sections 4 of the powder supply device 2 are generally in the horizontal arrangement. In addition, in a case in which the processing subject 1 is in the vertical arrangement, the plurality of accommodation sections 4 of the powder supply device 2 are generally in the vertical arrangement.

In addition, the plurality of transport sections 5 are not limited to the aspect of being connected in communication between one side of the accommodation section 4 in a longitudinal direction and an opposite side of the supply section 3 in the longitudinal direction, and may connect to one side of the accommodation section 4 in the longitudinal direction and one side of the supply section 3 in the longitudinal direction or the opposite side of the accommodation section 4 in the longitudinal direction and the opposite side of the supply section 3 in the longitudinal direction.

Further, the plurality of transport sections 5 (for example, 5a to 5e) need only have a configuration that is shareable for at least the processing subjects 1 of which the processing order is changeable. That is, among the plurality of transport sections 5, the transport sections 5 having the shareable configuration need only be provided corresponding to the processing subjects 1 of which the processing order is changeable. Therefore, for the plurality of processing subjects 1 of which the processing order is fixedly determined without being changed, the corresponding transport sections 5 need not have the shareable configuration. However, the corresponding transport sections 5 may have the shareable configuration.

Next, a typical aspect or a desired aspect of the powder supply device 2 according to the present exemplary embodiment will be described.

First, examples of the typical aspect of the present example include an aspect in which the plurality of processing subjects 1 are changeable between a most upstream color and a most downstream color in the processing order of the plurality of colors.

In general, in a case in which the arrangement interval p1 between the plurality of processing subjects 1 and the arrangement interval p2 between the plurality of accommodation sections 4 are different from each other, for example, in an aspect in which the plurality of transport sections that are connected in communication between the plurality of processing subjects 1 and the plurality of accommodation sections 4 extend in the longitudinal direction of the processing subjects, the transport sections have different arrangement angles and different transport lengths. In particular, in an aspect in which the arrangement is made with reference to the processing subject 1 of the most upstream color or the most downstream color, in a case in which the processing subjects 1 of the most upstream color and the most downstream color are changed, the arrangement angle and the transport length of the transport section are greatly different, and thus it is necessary to exchange the transport section with another component in a case in which the arrangement is changed.

On the other hand, in the present example, as shown in FIG. 1C, in a case in which the processing order between the processing subject 1a (1) of the most upstream color and the processing subject 1e (1) of the most downstream color is changed, the transport section 5a (5) and the transport section 5e (5) can be shared.

In this case, as shown in FIGS. 1A and 1B, the processing subject 1a (1) of the most downstream color and the processing subject 1e (1) of the most downstream color are disposed with the greatest arrangement interval between the processing subject 1a (1) of the most downstream color and the processing subject 1e (1) of the most downstream color. However, in the present example, for example, in a case in which a line passing through a position at the center of an arrangement direction of the processing subject 1c (1) of the center color is used as a reference line Q, the arrangement interval (2×p1) between the reference line Q and the processing subject 1a (1) of the most upstream color and the arrangement interval (2×p1) between the reference line Q and the processing subject 1e (1) of the most downstream color are equal to each other.

In this case, it is assumed that the transport section 5c (5) for the processing subject 1c (1) of the center color is disposed to be substantially parallel to the reference line Q. In this case, the processing subject 1a (1) of the most upstream color and the processing subject 1e (1) of the most downstream color are in a symmetrical positional relationship with the reference line Q as the center. Then, an inclination angle of the transport section 5a (5) with respect to a reference parallel line parallel to the reference line Q of the processing subject 1a (1) of the most upstream color and an inclination angle of the transport section 5e (5) with respect to the reference parallel line parallel to the reference line Q of the processing subject 1e (1) of the most downstream color are substantially equal to each other. Therefore, the transport section 5a (5) and the transport section 5e (5) need only have a substantially equal transport path length, and have a substantially equal inclination angle with respect to a parallel reference line. Therefore, in the present example, the transport section 5a (5) for the processing subject 1a (1) of the most upstream color and the transport section 5e (5) for the processing subject 1e (1) of the most downstream color can have a shareable configuration.

The plurality of processing subjects 1 may be changeable between colors other than the most upstream color and the most downstream color. In this case, in a case in which the processing subject 1 is changeable even between the colors other than the most upstream color and the most downstream color, the corresponding transport section 5 need only have a shareable configuration.

Further, although, in the present example, the plurality of colors may be only cyan (C), magenta (M), yellow (Y), and black (K), for example, an aspect including a spot color separately is preferable. A case of including the spot color is, for example, preferable in that the spot color (for example, clear or white) is disposed at the most upstream color or the most downstream color, whereby changing the processing order of the processing subject 1 has a larger effect on the processing result of the powder than in a case of only the four colors for full-color printing.

Examples of the typical aspect of the plurality of transport sections 5 include an aspect in which the plurality of transport sections 5 include transport path components that have equal transport path lengths and transport members that transport the powder along the transport path components, for the processing subjects 1 of which the processing order is changeable.

Here, even in a case in which a transport path trajectory of the transport section 5 is slightly changed in a case in which the transport section 5 is configured to be shareable, for example, an aspect is preferable in which the transport path component is made of a flexible resin pipe. In this case, the flexibility of the transport path component enables easily absorption of the slightly change in the transport path trajectory of the transport section 5.

In addition, even in a case in which the transport path length of the transport section 5 is slightly different in a case in which the transport section 5 is configured to be shareable, for example, an aspect is preferable in which the transport path component has an expansion and contraction portion that is deformable in an expansion and contraction manner, at a part of the transport path component. In this case, the transport path length of the transport section 5 can be adjusted by the expansion and contraction portion of the transport path component.

Examples of the desired aspect of the plurality of transport sections 5 include an aspect in which the transport section 5 is connected in communication between one side of the accommodation section 4 in the longitudinal direction and the opposite side of the supply section 3 in the longitudinal direction. In the present example, it is possible to sufficiently ensure the transport path length of the transport section 5. Therefore, a case in which the transport section 5 has a shareable configuration is, for example, preferable in that the slightly change in the transport path length is easily absorbed as compared to a case in which the transport path length of the transport section 5 is short.

Examples of the desired aspect of the plurality of transport sections 5 include an aspect in which the plurality of transport sections 5 are disposed symmetrically with respect to a center of an arrangement order of the plurality of processing subjects 1.

In this case, in an aspect in which the plurality of processing subjects 1 are changeable between a most upstream color and a most downstream color in the processing order, in a case in which the processing subject 1a (1) of the most upstream color and the processing subject 1e (1) of the most downstream color are changed, as shown in FIG. 1C, the transport section 5 (5a, 5e) need only be disposed such that an angle is changeable with a transport drive unit (not shown) provided on one end side of the transport section 5 (5a, 5e) as a fulcrum.

Hereinafter, the present invention will be described in more detail based on the exemplary embodiment shown in the accompanying drawings.

### Exemplary Embodiment 1

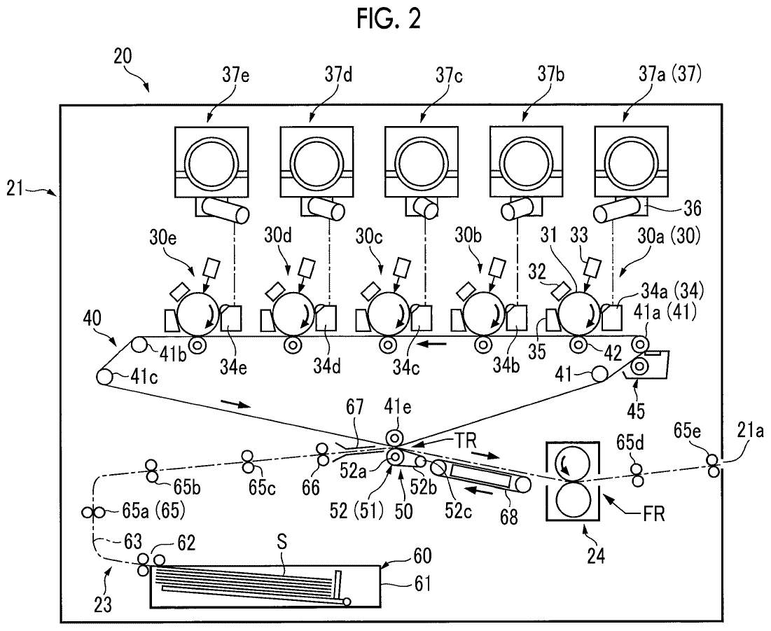

FIG. 2 is an explanatory diagram showing an overall configuration of the image forming system as the powder processing system according to Exemplary Embodiment 1.

### Overall Configuration of Image Forming System

In FIG. 2, the image forming system 20 includes a device housing 21 with a required outer appearance shape. Major elements such as an imaging engine 22, a medium transport system 23, and a fixing device 24 are mounted in an internal space of the device housing 21.

### Imaging Engine

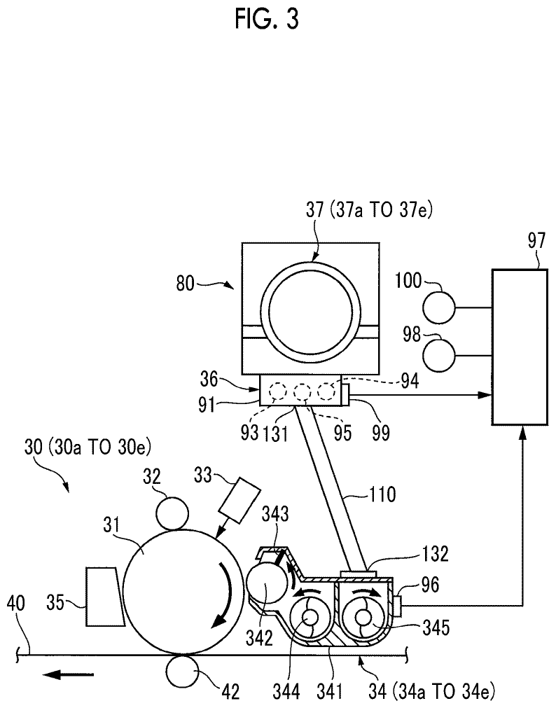

In FIG. 3, the imaging engine 22 includes a plurality of (five in the present example) image forming portions 30 (specifically, 30a to 30e) that form images of a plurality of (five in the present example) color components, an intermediate transfer body 40 that sequentially performs primary transfer of the images of the respective color components formed by the plurality of image forming portions 30 to hold the images, and transports the images to a position for the transfer to the medium, and a transfer device 50 that performs secondary (batch) transfer of the images of the respective color components held by the intermediate transfer body 40 to the medium.

In the present example, each image forming portion 30 (30a to 30e) forms an image of each color component including white (W) as the spot color, and cyan (C), magenta (M), yellow (Y), and black (K), which are the four colors used for full-color printing. In the present example, in the arrangement of the image forming portions 30 (30a to 30e), white (W) is the most upstream color, yellow (Y), magenta (M), and cyan (C) are arranged in this order toward the downstream side, and black (K) is the most downstream color. However, the arrangement of the image forming portions 30 (30a to 30e) may be changed as appropriate. For example, the arrangement may be adopted in which white (W) is the most downstream color, and black (K) is the most upstream color. It goes without saying that the plurality of image forming portions 30 may also include an image forming portion that forms an image of other color components (transparent (clear) or a spot color of a special color component). Further, in the present example, the imaging engine 22 forms the image on the medium via the intermediate transfer body 40, but the imaging engine 22 may form the image directly on the medium without passing through the intermediate transfer body 40.

### Image Forming Portion

In FIG. 3, each of the image forming portions 30 (30a to 30e) adopts an electrophotographic method. In the present example, each of the image forming portions 30 (30a to 30e) has a photoconductor 31 that rotates in a predetermined direction. Then, devices such as a charger 32, an exposure device 33, a developing device 34, and a cleaning device 35 are disposed in order around the photoconductor 31.

Here, the photoconductor 31 is formed in, for example, a drum shape and has a photosensitive layer serving as an image forming surface and an image holding surface, on a surface thereof. In addition, the charger 32 charges an outer peripheral surface of the photoconductor 31 to a required surface potential. As the charger 32, for example, a non-contact charging method using a corona discharge or a contact charging method using a charging roll is adopted.

Further, the exposure device 33 irradiates the outer peripheral surface of the photoconductor 31 with light in accordance with image information to form an electrostatic latent image for each color component image. As the exposure device 33, a light irradiation device such as a laser scanner or an LED array is used. In the present example, the exposure device 33 is individually provided for each of the image forming portions 30 (30a to 30e), but a part or all of the exposure devices 33 may be shared.

In addition, the developing device 34 (in the present example, 34a to 34e) uses a developer containing each color component toner as an example of the imaging material, and develops each electrostatic latent image on the photoconductor 31 as an image formed using each color component toner. Further, a toner replenishing mechanism 36 is provided in an upper space portion of the developing device 34 of each image forming portion 30, and is connected to each developing device 34 in communication. A toner cartridge 37 including a container that accommodates a toner for replenishment is attachably and detachably provided in each toner replenishing mechanism 36.

In addition, the cleaning device 35 is provided downstream of a primary transfer portion of the photoconductor 31 to the intermediate transfer body 40 in a rotation direction of the photoconductor 31. The cleaning device 35 cleans the residues such as the toner remaining on the photoconductor 31 after the primary transfer.

In the present example, the electrophotographic method using the photoconductor 31 and the exposure device 33 is adopted, but the present invention is not limited to this, and it goes without saying that the electrostatic recording method using a dielectric and an ion flow recorder may be adopted.

### Intermediate Transfer Body

In the present example, the intermediate transfer body 40 consists of, for example, an endless belt member made of a polyimide resin or the like. The intermediate transfer body 40 is bridged over a plurality of (six in the present example) tension rolls 41 (specifically, 41a to 41f). In the present example, among the plurality of tension rolls 41, for example, the tension roll 41a is used as a driving roll, and the other tension rolls 41b to 41f are used as driven rolls. In the present example, the photoconductors 31 of the image forming portions 30 are arranged at predetermined intervals to face a horizontal portion of the intermediate transfer body 40, which is bridged between the tension rolls 41a and 41b.

On a back surface of the horizontal portion of the intermediate transfer body 40, the primary transfer device 42 is provided to face the photoconductor 31 of each image forming portion 30. Each primary transfer device 42 electrostatically transfers the image formed by each image forming portion 30 to the intermediate transfer body 40. Here, the primary transfer device 42 may be appropriately selected as long as the primary transfer device 42 causes a transfer electric field for attracting the image on the photoconductor 31 to the intermediate transfer body 40 side to act. For example, a transfer member (for example, a transfer roll, a discharge wire for generating a corona discharge, or the like) need only be installed to face the photoconductor 31, and a transfer voltage for primary transfer need only be applied to the transfer member.

Further, an intermediate transfer body cleaning device 45 is provided on an outer peripheral surface of the intermediate transfer body 40, which is bridged over the tension roll 41a. The intermediate transfer body cleaning device 45 cleans the residues such as the toner, paper dust, and the like remaining on the intermediate transfer body 40 after the image is transferred to the medium.

### Transfer Device

In the present example, the transfer device 50 is provided on an outer peripheral surface of the intermediate transfer body 40, which is bridged over the tension roll 41e. The transfer device 50 electrostatically transfers the image held on the intermediate transfer body 40 to the medium. Here, the transfer device 50 may be appropriately selected as long as the transfer device 50 causes a transfer electric field for attracting the image on the intermediate transfer body to the medium side to act. For example, the transfer member 51 may be installed to face the tension roll 41e of the intermediate transfer body 40, and a transfer voltage for secondary transfer need only be applied to the transfer member 51 or the tension roll 41e to form a transfer electric field for secondary (batch) transfer between the transfer member 51 and the tension roll 41e. In the present example, a transfer belt module 52 is adopted as the transfer member 51. The transfer belt module 52 has an aspect in which a transfer belt 52c is bridged between a transfer roll 52a and a peeling roll 52b. In the present example, a transfer electric field is formed between the transfer roll 52a and the tension roll 41e, and an action region of the transfer electric field acts as a transfer region TR. A medium S receives the image transfer operation in the transfer region TR, passes through the transfer region TR, is guided along the transfer belt 52c, and is peeled off by the peeling roll 52b.

The transfer member 51 is not limited to the transfer belt module 52, and an aspect in which only the transfer roll is used or a discharge wire using a corona discharge or the like may be appropriately selected.

### Medium Transport System

In the present example, the medium transport system 23 includes a medium supply device 60 that supplies the medium S. In the present example, a sheet-like medium S cut to a predetermined size is used. This medium supply device 60 accommodates the medium S in an accommodation container 61 and sends out the medium S one by one by a feeder 62. In the present example, one accommodation container 61 is provided, but a plurality of accommodation containers 61 may be provided.

In addition, a vertical transport path 63 that transports the medium S supplied from the medium supply device 60 in a substantially vertical direction is provided in the device housing 21. A horizontal transport path 64 that transports the medium S in a substantially horizontal direction is provided on an upper side of the vertical transport path 63. Here, the horizontal transport path 64 extends to a discharge port 21a open in a side wall of the device housing 21. In addition, a discharge receiver (not shown) that receives the discharged medium S is provided outside the discharge port 21a of the device housing 21. An appropriate number of transport rolls 65 (specifically, 65a to 65e) are provided in the vertical transport path 63 and the horizontal transport path 64. The transport roll 65e provided immediately before the discharge port 21a functions as a discharge roll that discharges the medium S to the discharge receiver.

Further, in the horizontal transport path 64, an alignment roll 66 is provided upstream of the transfer region TR of the transfer device 50 in the transport direction of the medium S. The alignment roll 66 aligns the leading end of the medium S supplied from the medium supply device 60 and then sends out the medium S toward the transfer region TR at an appropriate timing. Further, a guide member 67 that guides the medium S toward the transfer region TR is provided between the alignment roll 66 and the transfer region TR.

In addition, in the horizontal transport path 64, a transport belt 68 is provided downstream of the transfer device 50 in the transport direction of the medium S. The transport belt 68 transport the medium S on which the unfixed image is held, by stably holding the medium S in a state of being electrostatically attracted.

Further, in the horizontal transport path 64, the fixing device 24 is provided downstream of the transport belt 68 in the transport direction of the medium S.

In the present example, the medium transport system 23 has the aspect in which only the vertical transport path 63 and the horizontal transport path 64 are provided, but the present invention is not limited to this. For example, a reversible branch transport path (not shown) that branches downward between the fixing device 24 and the post-processing device 25 may be provided in the horizontal transport path 64. In the aspect in which the branch transport path is provided, the medium reversed by the branch transport path may be returned to the vertical transport path 63 again from the horizontal transport path 64 through a return transport path. In this case, it is possible to transfer the image to the back surface of the reversed medium in the transfer region TR. In addition, a branch return transport path that branches from the middle in the branch transport path may be provided, and the reversed medium may be discharged to the discharge receiver outside the device housing 21.

### Fixing Device

In the present example, as shown in FIG. 2, the fixing device 24 performs heating and pressurization to fix the image on the medium S. The fixing device 24 includes a heating roll 71 as the fixing member for heating and a pressure roll 72 as the fixing member for pressurization. The heating roll 71 is disposed in contact with an image holding surface side of the medium S and rotates via a drive force from a drive source (not shown). On the other hand, the pressure roll 72 is disposed to face the heating roll 71 in a strongly pressed manner and rotates following the heating roll 71. Therefore, the fixing device 24 allows the image G formed using the toner held on the medium S to pass through a fixing region FR between the heating roll 71 and the pressure roll 72, and performs heating and pressurization to fix the image G.

In the present example, the heating roll 71 is formed in an aspect in which a heater (not shown) is built in a roll body (not shown) made of metal having a high thermal conductivity. Here, a heating method of the heating roll 71 is not limited to this, and the roll body may be heated by bringing an external heater (not shown) into contact with an outer peripheral surface of the roll body.

On the other hand, the pressure roll 72 is formed by laminating a heat-resistant elastic layer around a core bar made of metal, and coating a surface of the elastic layer with a protective layer. A heater may be added to the pressure roll 72 as necessary.

In the present example, the medium S is allowed to, in a state of being nipped by the elastic deformation of the pressure roll 72, pass through the fixing region FR between the heating roll 71 and the pressure roll 72 and the image G on the medium S is heated and pressurized.

In the present example, the fixing device 24 has a roll pair configuration, but the present invention is not limited to this, and the fixing device 24 may be appropriately selected, for example, to be configured with a heating belt in which an electromagnetic induction heating method is adopted, instead of the heating roll 71.

### Toner Supply System

In the present example, a toner supply system as the powder supply device is provided. The toner supply system includes a developing device 34, a toner cartridge 37, a toner replenishing mechanism 36, and a transport path component 110.

### Configuration Example of Developing Device

In the present example, the developing device 34 (34a to 34e) of each image forming portion 30 adopts a two-component development method using a two-component developer containing a toner and a carrier, as shown in FIG. 3. The developing device 34 includes a developer housing 341 that accommodates the developer. The developer housing 341 has an opening facing the photoconductor 31, and a developing roll 342 is disposed to face the photoconductor 31 at a portion facing the opening. The developing roll 342 is provided with a sleeve that can rotate around a magnetic roll in which magnets are arranged in a circumferential direction. In addition, a layer thickness restricting member 343 is provided at a portion facing the developing roll 342. Therefore, the developing roll 342 rotates and moves while holding the developer on a sleeve surface, and the developer is restricted to an appropriate layer thickness by the layer thickness restricting member 343 and then is transported to a development region facing the photoconductor 31. Further, a pair of developer agitating members 344 and 345 that extend along an axial direction of the developing roll 342 are provided in the developer housing 341. The developer agitating members 344 and 345 are provided with spiral blade members around a rotation axis, and charge and transport the developer while agitating the developer.

### Structure of Toner Cartridge

In the present example, each toner cartridge 37 (specifically, 37a to 37e) is a replaceable cartridge-type toner accommodation container as shown in FIGS. 2 to 4. The toner cartridge 37 includes a container that accommodates, as an example of the powder, the toner of any one of the respective colors or the toner containing a small amount of the carrier for the developing device 34 (34a to 34e) of each image forming portion 30. The toner cartridge 37 is attachably and detachably attached to an attachment device 80.

In the present example, as shown in FIG. 3, the toner cartridge 37 includes a cylindrical container body 371 and an end portion holding frame 372 that rotatably holds an end portion on a back side of the container body 371 in the longitudinal direction. In the present example, an openable and closable discharge port 375 is provided at the end portion on the back side of the container body 371 in the longitudinal direction. In addition, a spiral groove 373 is provided on an outer peripheral surface of the container body 371 at an appropriate pitch. The spiral groove 373 has a shape that spirally protrudes inside the container body 371. Therefore, in a case in which the container body 371 rotates in a certain direction, the accommodated toner functions as a transport protrusion that transports the toner toward the discharge port 375. A handle portion 374 is provided at an end portion on a front side of the container body 371 in the longitudinal direction.

Each developing device 34 (34a to 34e) is replenished with the toner accommodated in the container of the toner cartridge 37 via the toner replenishing mechanism 36 disposed below the attachment device 80.

In addition, in the present example, the transport path component 110 as the transport section for the toner is installed between each toner replenishing mechanism 36 and each developing device 34.

### Attachment Structure Example of Cartridge

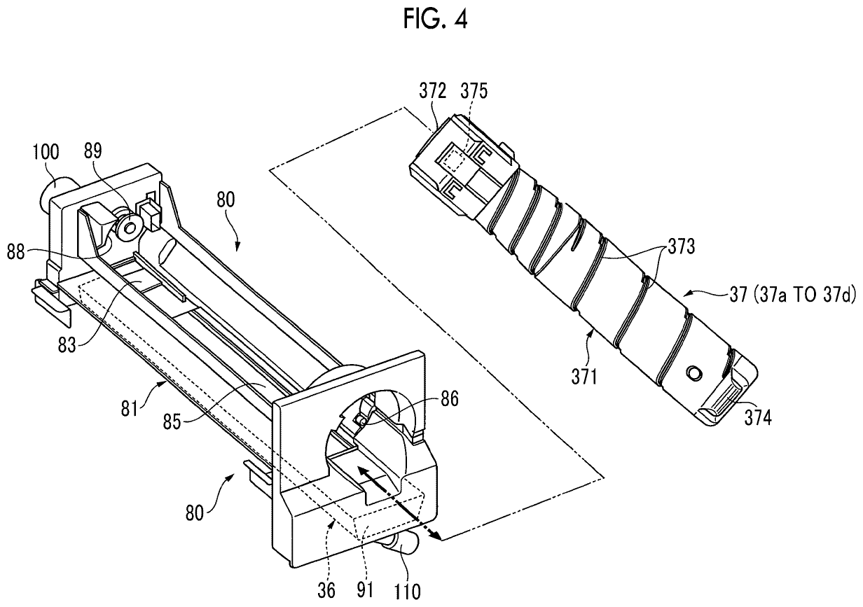

In the present example, as shown in FIGS. 3 and 4, the attachment device 80 includes an attachment portion 81 to which the toner cartridge 37 is attachably and detachably attached by a pushing operation and a pulling operation. Further, the attachment portion 81 is provided with a receiving port (not shown) that receives the toner supplied from the toner cartridge. In addition, the attachment portion 81 is provided with an opening and closing lid 83 that opens and closes the receiving port in conjunction with the pushing operation and the pulling operation of the toner cartridge 37.

Further, the attachment portion 81 includes a base 85 that supports the toner cartridge 37, and a rotation roller 86 that rotatably supports the toner cartridge 37 is provided on the base 85. Further, a holding portion 87 that holds the end portion holding frame 372 of the toner cartridge 37 is provided on the back side of the attachment portion 81 in the longitudinal direction. A coupling 89 that transmits a rotational drive force from a motor 100 to the container body 371 of the toner cartridge 37 is provided in the holding portion 87.

### Toner Replenishing Mechanism

As shown in FIGS. 3 and 4, the toner replenishing mechanism 36 includes a replenishing housing 91 in which the receiving port (not shown) for receiving the toner supplied from the toner cartridge 37 via the attachment device 80 is formed on an upper surface portion. A pair of transport members 93 and 94 that are disposed parallel to each other are disposed inside the replenishing housing 91. The transport members 93 and 94 cause the toner to circulate to be transported within the replenishing housing 91. A send-out member 95 that faces the connection port 131 with the transport path component 110 and rotates at a required time is provided at a position between the transport members 93 and 94. The send-out member 95 sends out the toner in the replenishing housing 91 toward each developing device 34.

### Toner Replenishment Control to Developing Device

The toner replenishment control via the toner cartridge 37 and the toner replenishing mechanism 36 is performed as follows.

As shown in FIG. 3, an amount of the developer (an amount of the toner in a case of the two-component developer) accommodated in each developing device 34 is detected by a detection sensor 96. The control device 97 detects detection information from the detection sensor 96 and determines whether or not the toner in the developing device 34 is insufficient. Then, the control device 97 drives a motor 98 and the like for the required time to rotate the send-out member 95.

In addition, the toner is also supplied to the toner replenishing mechanism 36 from the toner cartridge 37. In the present example, a detection sensor 99 that detects an amount of the toner in the replenishing housing 91 is provided. In a case in which the detection sensor 99 detects that the amount of the toner in the replenishing housing 91 is insufficient, the control device 97 receives detection information of the detection sensor 99 to drive the transport member that sends out the toner in the toner cartridge 37 or the motor 100 that rotates the toner cartridge 37 for the required time.

### Transport Path Component

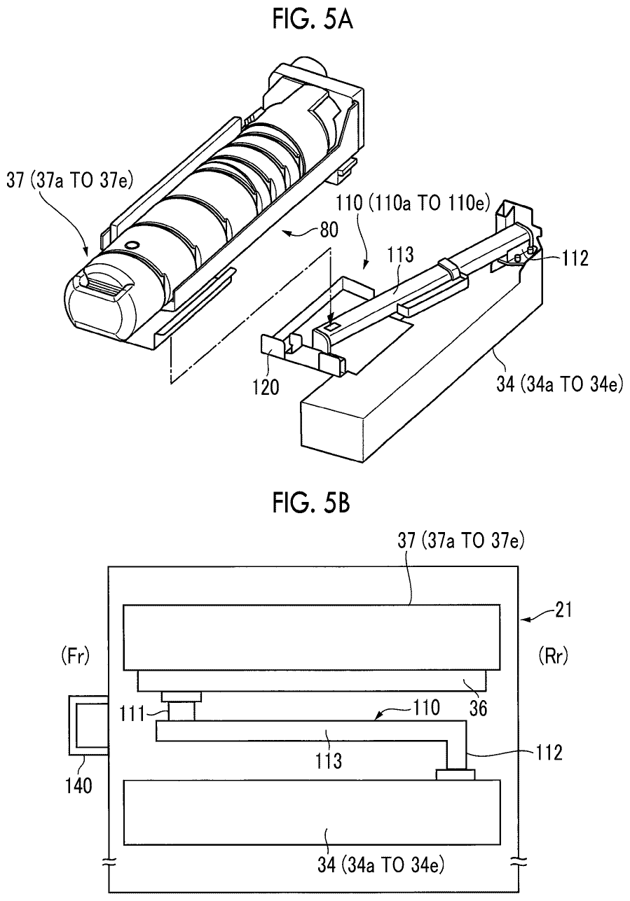

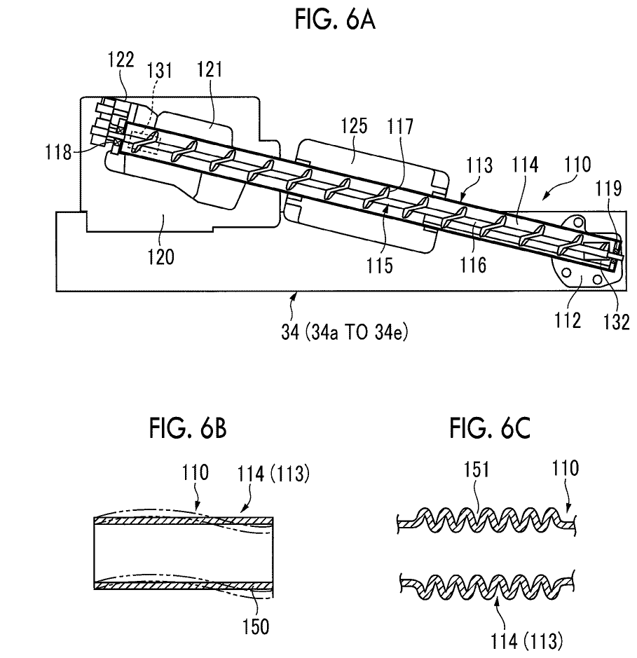

In the present example, as shown in FIGS. 5A, 5B, and 6A, the transport path component 110 includes a first connection tube 111 that is connected in communication to the connection port 131 of the replenishing housing 91 of the toner replenishing mechanism 36, a second connection tube 112 that is connected in communication to the connection port 132 provided in the developer housing 341 of the developing device 34, and a transport path tube 113 that is connected in communication to the first connection tube 111 and the second connection tube 112. In FIG. 5B, reference numeral Fr indicates the front side of the device housing 21 in the user's operation direction, and reference numeral Rr indicates the back side.

Here, the first connection tube 111 and the second connection tube 112 may be molded as separate parts from the transport path tube 113, or may be integrally molded with the transport path tube 113 in advance.

In the present example, the first connection tube 111 and the second connection tube 112 are fixedly connected to the replenishing housing 91 and the developer housing 341 by fasteners such as screws. In the present example, the first connection tube 111 and the second connection tube 112 extend in a substantially vertical direction. The first connection tube 111 causes the toner in the toner replenishing mechanism 36 to fall in a substantially vertical direction by a dead weight. In addition, the second connection tube 112 causes the toner in the transport path tube 113 to fall in a substantially vertical direction by a dead weight.

In addition, in the present example, the first connection tube 111 is connected to the front side of the replenishing housing 91 in the longitudinal direction, and the second connection tube 112 is connected to the back side of the developer housing 341 in the longitudinal direction. Therefore, the transport path tube 113 is bridged between the first connection tube 111 and the second connection tube 112 and is disposed to extend from the front side to the back side along the longitudinal direction of the developer housing 341.

In the present example, as shown in FIGS. 5A to 6C, the transport path tube 113 includes a cylindrical transport pipe 114 that partitions the transport path and a transport member 115 that extends along the longitudinal direction of the transport pipe 114.

In the present example, the transport pipe 114 is made of, for example, a pipe member made of synthetic resin. In addition, the transport pipe 114 is held via a holding bracket 121 by a support plate 120 provided in a part of the device housing 21.

Further, the transport member 115 is provided with a spiral blade member 117 around a rotation shaft 116 extending in the longitudinal direction of the transport pipe 114. Both ends of the transport pipe 114 are sealed, and both ends of the transport member 115 are rotatably supported via bearings 118 and 119. Further, a rotation drive unit 122 that rotationally drives the transport member 115 is provided on one end side of the rotation shaft 116 of the transport member 115. In the present example, the rotation drive unit 122 is provided on the support plate 120. The rotation drive unit 122 includes a motor and a drive transmission mechanism that transmits a drive force from the motor. Reference numeral 125 indicates a holder that holds the transport path tube 113 in the middle and is fixed to a support frame (not shown) or the like in the device housing 21.

### Arrangement Positional Relationship Between Each Toner Cartridge 37 and Each Photoconductor 31 (Developing Device 34)

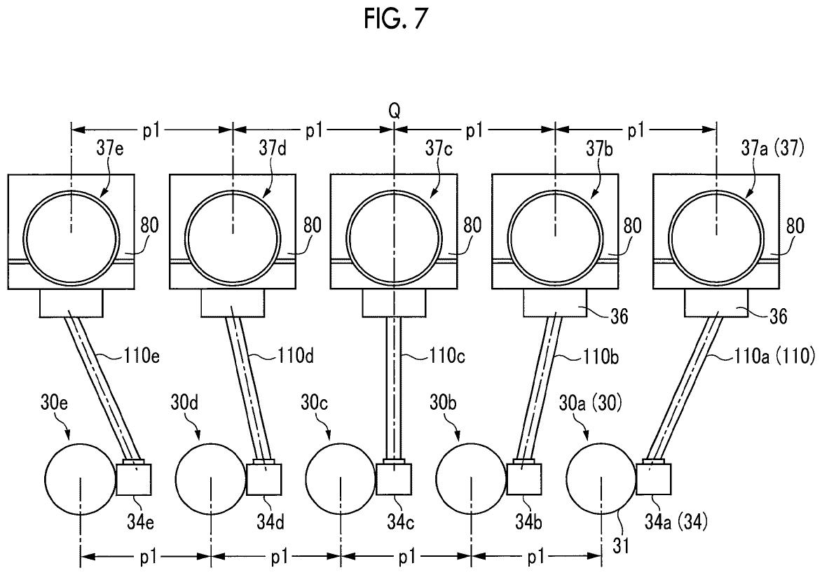

In the present example, in a case in which the arrangement interval between the centers of the respective photoconductors 31 of the respective image forming portions 30 (30a to 30e: arrangement order from the most upstream side is #1 to #5) is denoted by p1 and the arrangement interval between the centers of the respective toner cartridges 37 is denoted by p2, as shown in FIG. 7, a relationship of p2>p1 is satisfied in accordance with the increase in the toner capacity of the toner cartridge 37.

In the present example, each toner cartridge 37 is attachably and detachably attached to the attachment device 80. In the present example, each image forming portion 30 and each toner cartridge 37 are arranged with reference to the image forming portion 30c of the color (in the present example, magenta M: #3) located in the middle between the image forming portion 30a of the most upstream color (in the present example, white W: #1) and the image forming portion 30e of the most downstream color (in the present example, black K: #5).

In the present example, an arrangement positional relationship between each of the image forming portions 30 (30a to 30e) and each toner cartridge 37 is selected with the position of the developing device 34 as a reference.

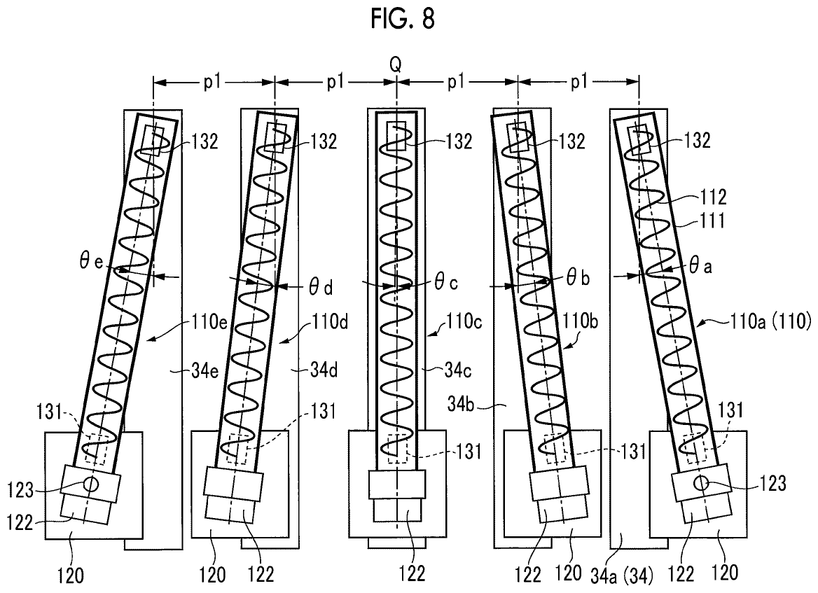

In the present example, as shown in FIGS. 7 and 8, first, the respective image forming portions 30 (30a to 30e) are arranged at the arrangement interval p1 between the centers of the photoconductors 31.

On the other hand, the respective toner cartridges 37 (37a to 37e) are arranged at the arrangement interval p2 between the centers of the toner cartridges 37. However, the reference line Q passing through the center of the toner cartridge 37c (37) of magenta is selected in accordance with the position of the developing device 34c of the image forming portion 30c of magenta.

Therefore, in the present example, as shown in FIG. 8, the transport path components 110 from the respective toner cartridges 37 (37a to 37e) to the respective image forming portions 30 (30a to 30e) are disposed symmetrically with respect to the reference line Q of the image forming portion 30c of magenta (M: #3).

That is, the transport path component 110c directed toward the image forming portion 30c of magenta (M: #3) is disposed in a direction along the reference line Q. Therefore, an inclination angle θc between a disposition posture of the transport path component 110c of magenta (M) and the reference line Q is approximately zero.

Further, the transport path component 110a directed toward the image forming portion 30a of white (W: #1) of the most upstream color and the transport path component 110e directed toward the image forming portion 30e of black (K: #5) of the most downstream color are disposed at positions symmetrical with respect to the reference line Q. Therefore, the transport path component 110a of the most upstream color and the transport path component 110e of the most downstream color are symmetrically disposed with respect to the parallel reference line parallel to the reference line Q at the inclination angles θa and θe, respectively. Therefore, in the present example, the transport path component 110a (mostly the transport path tube 113) of the most upstream color and the transport path component 110e (mostly the transport path tube 113) of the most downstream color are common in that the transport path component 110a and the transport path component 110e are components having the equal transport path lengths L.

In addition, the transport path component 110b directed toward the image forming portion 30b of yellow (Y: #2) adjacent to the image forming portion 30c of magenta and the transport path component 110d directed toward the image forming portion 30d of cyan (C: #4) are disposed at positions symmetrical with respect to the reference line Q. Therefore, the transport path component 110b of yellow (Y: #2) and the transport path component 110d of cyan (C: #4) are disposed symmetrically with respect to the parallel reference line parallel to the reference line Q at the inclination angles θb and θd, respectively. Therefore, in the present example, the transport path component 110b (mostly the transport path tube 113) of yellow (Y: #2) and the transport path component 110d (mostly the transport path tube 113) of cyan (C: #4) are common in that the transport path component 110b and the transport path component 110d are components having the equal transport path lengths L1.

In this way, in the present example, the transport path component 110a of white (W: #1) of the most upstream color and the transport path component 110e of black (K: #5) of the most downstream color are different in that the disposition relationship is symmetrical, but can be produced as shareable components having the equal transport path lengths L for the configuration as an individual component.

Further, in the present example, the transport path component 110b of yellow (Y: #2) and the transport path component 110d of cyan (C: #4) are different in that the disposition relationship is symmetrical, but can be produced as shareable components having the equal transport path lengths L1 for the configuration as an individual component.

### Countermeasure for Changing Processing Order Between Most Upstream Color and Most Downstream Color

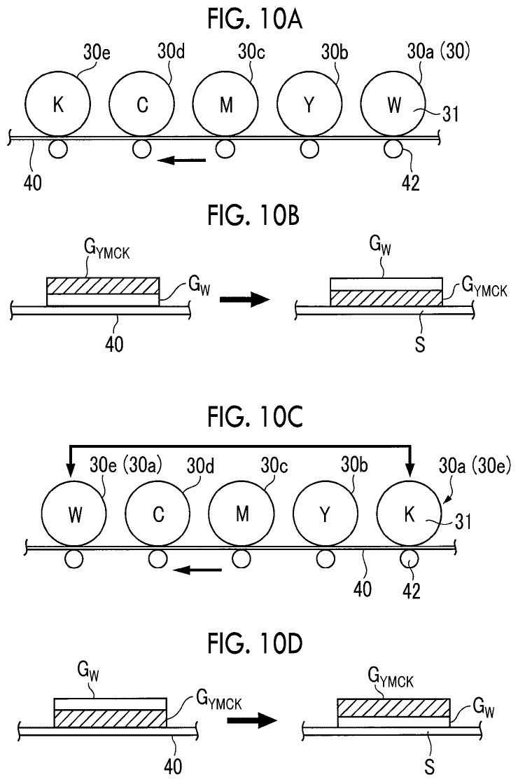

In the present example, as shown in FIG. 10A, the most upstream color is the image forming portion 30a of white (W), and the most downstream color is the image forming portion 30e of black (K).

In this state, in a case in which a toner image of each color is formed by each of the image forming portions 30a to 30e, as shown in FIG. 10B, a multiple image in which a color image portion G_{YMCK} is laminated on a white image portion G_{W} is obtained on the intermediate transfer body 40. Therefore, in the transfer device 50, in a case in which the image G on the intermediate transfer body 40 is collectively transferred to the medium S, a multiple image in which the white image portion G_{W} is laminated on the color image portion G_{YMCK} is obtained on the medium S.

On the other hand, in a case in which the processing order between the image forming portion 30a of the most upstream color and the image forming portion 30e of the most downstream color is changed, as shown in FIG. 10C, the black (K) toner need only be used in the image forming portion 30a of the most upstream color, and the white (W) toner need only be used in the image forming portion 30e of the most downstream color.

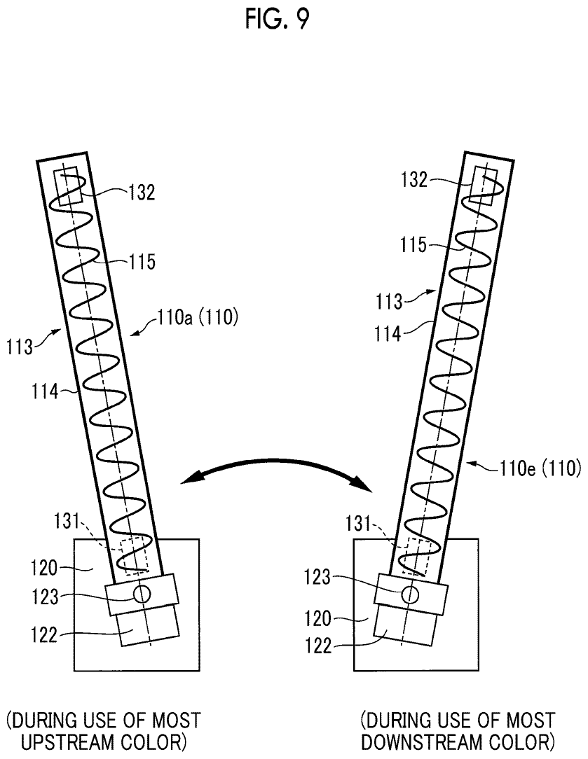

In this case, as shown in FIG. 9, in order to use the white (W) toner in the image forming portion 30a of the most upstream color, the image forming portion 30e or the developing device 34e used in the image forming portion 30e of the most downstream color need only be assembled in the image forming portion 30a of the most upstream color. Further, the toner cartridge 37e, the toner replenishing mechanism 36, and the transport path component 110e of the most downstream color need only be used as the toner cartridge 37a, the toner replenishing mechanism 36, and the transport path component 110a of the most upstream color.

On the contrary, the image forming portion 30a or the developing device 34a used in the image forming portion 30a of the most upstream color need only be assembled in the image forming portion 30e of the most downstream color. Further, the toner cartridge 37a, the toner replenishing mechanism 36, and the transport path component 110a of the most upstream color need only be used as the toner cartridge 37e, the toner replenishing mechanism 36, and the transport path component 110e of the most downstream color.

In this case, the transport path components 110a and 110e are shareable components having the equal transport path lengths L, and need only be installed, as shown in FIG. 9, by changing the disposition angle with the rotation drive unit 122 of the transport path components 110a and 110e as a fulcrum 123.

In a case in which the processing order between the most upstream color and the most downstream color is exchanged, as shown in FIG. 10C, in a case in which the toner image of each color is formed by each of the image forming portions 30a to 30e, as shown in FIG. 10D, a multiple image in which the white image portion G_{W} is laminated on the color image portion G_{YMCK} is obtained on the intermediate transfer body 40. Therefore, in the transfer device 50, in a case in which the image G on the intermediate transfer body 40 is collectively transferred to the medium S, a multiple image in which the color image portion G_{YMCK} is laminated on the white image portion G_{W} is obtained on the medium S. Therefore, as in the present example, in a case in which the processing order between the most upstream color and the most downstream color is changed, the white image portion G_{W} can be created as a base image on the medium S. Therefore, the white image portion G_{W} can be drawn on the medium of black color or the like.

### Cooling Structure for Toner Supply System

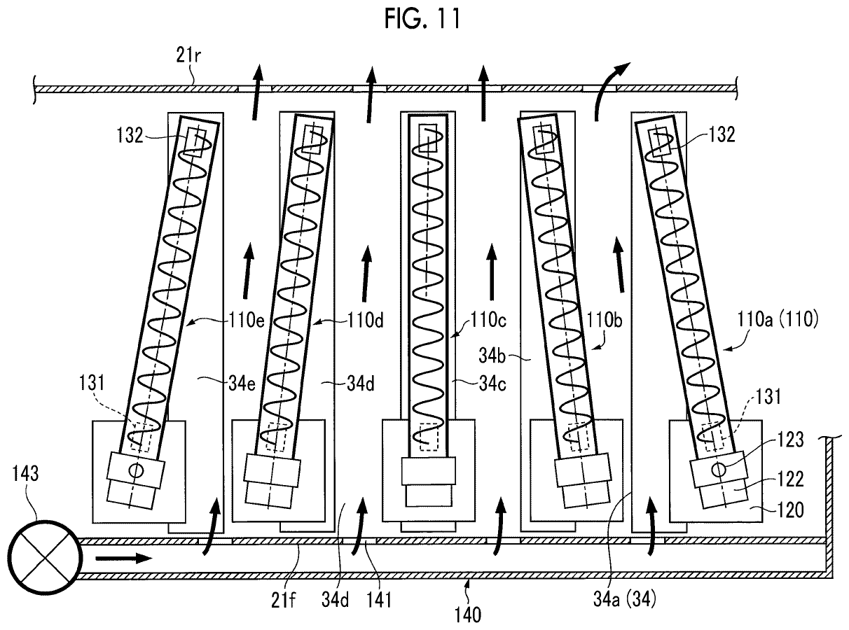

In the present example, as shown in FIG. 11, the transport path component 110 (110a to 110e) that connects the respective image forming portions 30 (30a to 30e) and the respective toner cartridges 37 (37a to 37e) is disposed between the front side and the back side of the device housing 21.

Therefore, in the present example, an air duct 140 that extends in the right-left width direction of the device housing 21 is formed, for example, on an outer side of a front frame 21f of the device housing 21. An inlet opening 141 for air circulation is provided in a cavity region between the respective transport path components 110 of the air duct 140. In addition, an outlet opening 142 for air circulation is provided to face a cavity region between the transportation path components 110 on a rear frame 21r of the device housing 21. In addition, a fan 143 is provided in a part of a side frame (not shown) of the device housing 21, and the air blown out from the fan 143 need only be directed to flow into the air duct 140.

According to the present example, the air from the fan 143 enters the inside of the device housing 21 from the inlet opening 141 through the air duct 140, and the air that has entered is directed toward the rear frame 21r side along each transport path component 110 and is discharged from the outlet opening 142.

In this state, an ambient temperature around the transport path component 110 in the device housing 21 is cooled by the air. Therefore, the temperature inside the device housing 21 around the transport path component 110 may not abnormally increase.

### Comparative Example 1

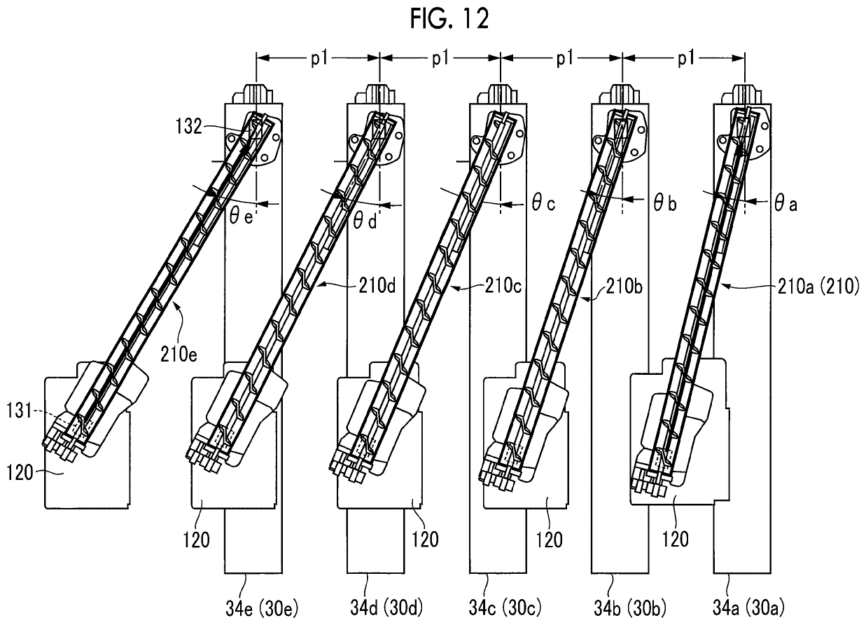

FIG. 12 shows a toner supply system of an image forming system according to Comparative Example 1.

In FIG. 12, in a case in which the arrangement interval between the centers of the respective photoconductors 31 of the respective image forming portions 30 (30a to 30e) is denoted by p1 and the arrangement interval between the centers of the respective toner cartridges 37 is denoted by p2 (not shown in FIG. 12), the relationship of p2>p1 is satisfied in accordance with the increase in the toner capacity of the toner cartridge 37.

In the present example, the respective image forming portions 30 are disposed at the arrangement interval p1 with reference to the image forming portion 30a of the most upstream color (in the present example, white W), and further, the respective toner cartridges 37 are also arranged with reference to the most upstream color.

In a case of the present example, as shown in FIG. 12, in the respective transport path components 210 (210a to 210e), the arrangement angle between the toner cartridge (not shown) and the developing devices 34 (34a to 34e), that is, the inclination angles θ (θa to θe) with respect to the reference line Q or the parallel reference line parallel to the reference line Q are increased toward the most downstream color. That is, the inclination angles θ (θa<θb<θc<θd<θe) corresponding to the arrangement angles of the respective transport path components 210 (210a to 210e) and the transport path lengths are different from each other. In particular, in an aspect in which the image forming portions 30 (30a, 30e) of the most downstream color and the most upstream color are changed, the arrangement angles and the transport path lengths of the transport path components 210 are greatly different, and thus it is necessary to exchange the transport path component 210 with another component in a case in which the arrangement is changed.

### Modification Example 1

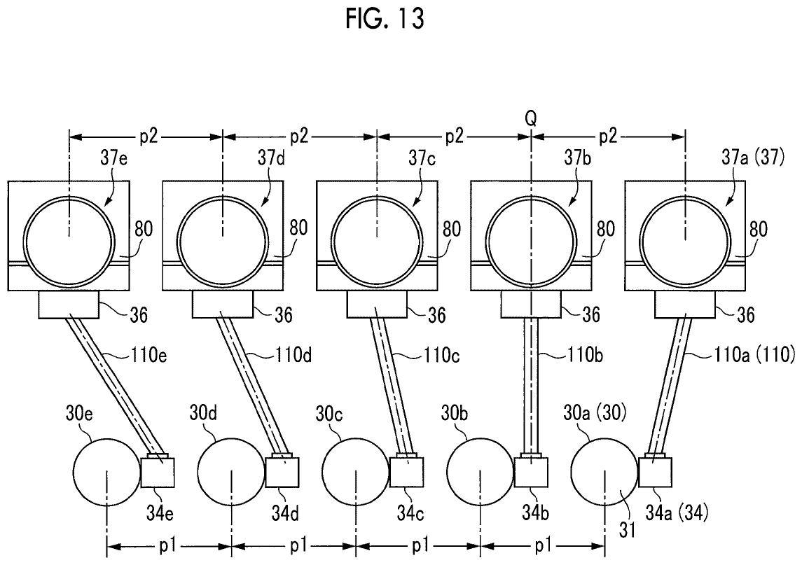

FIG. 13 shows a major part of a toner supply system of an image forming system according to Modification Example 1.

In FIG. 13, the arrangement interval p1 between the centers of the respective photoconductors 31 of the respective image forming portions 30 (30a to 30e) and the arrangement interval p2 between the centers of the respective toner cartridges 37 satisfy the relationship of p2>p1.

In the present example, unlike Exemplary Embodiment 1, the respective image forming portions 30 are disposed at the arrangement interval p1 with reference to the image forming portion 30b of yellow (Y: #2), and further, the respective toner cartridges 37 are also arranged with reference to yellow (Y).

In the present example, the transport path component 110a of the most upstream color and the transport path component 110e of the most downstream color are not disposed symmetrically with respect to the reference line Q of the image forming portion 30b of yellow (Y: #2).

However, the inclination angle θa of the transport path component 110a of the most upstream color with respect to the parallel reference line parallel to the reference line Q and the inclination angle θe of the transport path component 110e of the most downstream color with respect to the parallel reference line parallel to the reference line Q are different from each other, but are suppressed to be smaller than in a case of Comparative Example 1.

In the present example, in a case in which the processing order between the image forming portion 30a of the most upstream color and the image forming portion 30e of the most downstream color is changed, the transport path components 110 (110a and 110e) of the most upstream color and the most downstream color can be shared as follows.

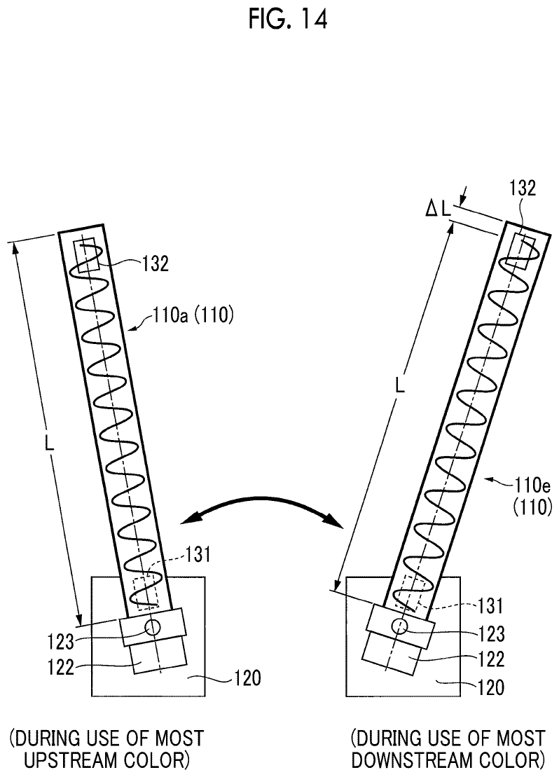

As one method, for example, as shown in FIG. 6B, the transport pipe 114, which is a component of the transport path tube 113 of the transport path component 110, need only be made of a flexible resin pipe 150. In the present example, even in a case in which the transport path length L is different due to the difference in the inclination angle, as shown in FIG. 14, a difference ΔL in the transport path length is effectively absorbed by the elasticity of the transport pipe 114. Therefore, the transport path components 110 (110a and 110e) of the most upstream color and the most downstream color can be shared.

In addition, as another method, as shown in FIG. 6C, an expansion and contraction portion 151 that is deformable in an expansion and contraction manner may be provided at a part of the transport pipe 114 of the transport path component 110. In the present example, as shown in FIG. 14, even in a case in which the transport path length L is different, the expansion and contraction portion 151 can effectively absorb the difference ΔL in the transport path length. Therefore, the transport path components 110 (110a and 110e) of the most upstream color and the most downstream color can be shared.

### Modification Example 2

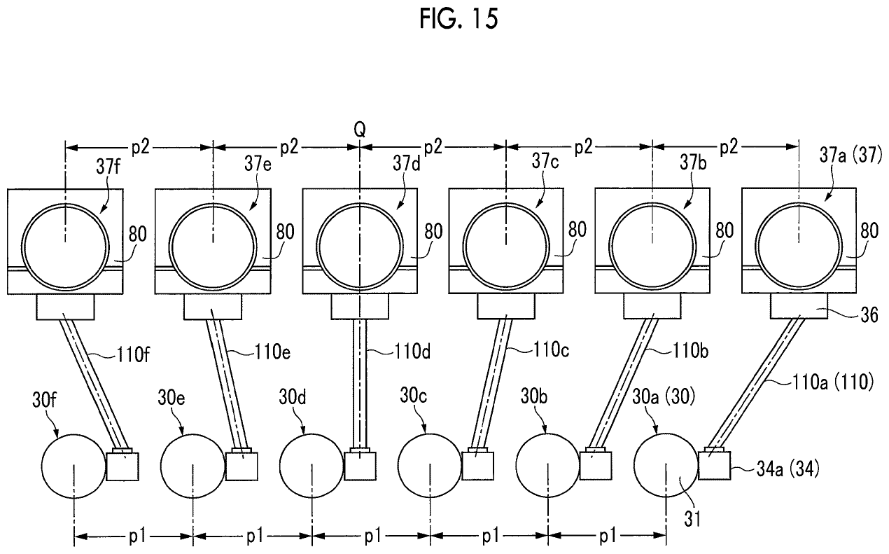

FIG. 15 shows a major part of a toner supply system of an image forming system according to Modification Example 2.

In FIG. 15, the image forming system has an aspect in which one element of the plurality of image forming portions 30 is increased as compared to Exemplary Embodiment 1.

In the present example, the image forming portions 30 (30a to 30f), for example, the most upstream color is the image forming portion 30a of clear (CL), and the second to most downstream colors are the image forming portions 30b to 30f of white (W), yellow (Y), magenta (M), cyan (C), and black (K).

In the present example, the respective image forming portions 30 are disposed at the arrangement interval p1 with reference to, for example, the image forming portion 30d of fourth magenta (M: #4), and similarly, the toner cartridges 37 (37a to 37f) are disposed at the arrangement interval p2 with reference to magenta (M).

In the present example, the transport path component 110a of the most upstream color and the transport path component 110f of the most downstream color are not disposed symmetrically with respect to the reference line Q of the image forming portion 30d of magenta (M: #4).

However, the transport path component 110b of second white (W: #2) and the transport path component 110f of black (K: #6) of the most downstream color are disposed symmetrically with respect to the reference line Q of the image forming portion 30d of magenta (M: #4).

Therefore, in a case in which the processing order between the image forming portion 30b of second white (W: #2) and the image forming portion 30f of black (K: #6) of the most downstream color is changed, the transport path component 110b and the transport path component 110f can be configured to be shareable.

### Supplementary Note

(((1)))

A powder supply device comprising:
a plurality of supply sections that are provided respectively for of a plurality of processing subjects arranged in a processing order of a plurality of colors at a predetermined interval and that supply powder divided into a plurality of color components to each processing subject;
a plurality of accommodation sections that are arranged at an interval wider than an arrangement interval between the plurality of processing subjects and that accommodate the powder divided into the plurality of color components; and
a plurality of transport sections that are respectively connected in communication between the plurality of accommodation sections and the plurality of supply sections and that transport the powder of each color component accommodated in each accommodation section to each supply section,
wherein the plurality of transport sections have a configuration that is shareable at least for the processing subjects of which the processing order is changeable.
   (((2)))

The powder supply device according to (((1))
wherein the plurality of processing subjects are changeable between a most upstream color and a most downstream color in the processing order of the plurality of colors.
   (((3)))

The powder supply device according to (((2))),
wherein the plurality of processing subjects are changeable between colors other than the most upstream color and the most downstream color.
   (((4)))

The powder supply device according to any one of (((1))) to (((3))),
wherein the plurality of colors include a spot color different from four colors of cyan, magenta, yellow, and black.
   (((5)))

The powder supply device according to (((4))),
wherein the spot color is clear or white.
   (((6)))

The powder supply device according to any one of (((1))) to (((5))),
wherein the plurality of transport sections include transport path components that have equal transport path lengths and transport members that transport the powder along the transport path components, for the processing subjects of which the processing order is changeable.
   (((7)))

The powder supply device according to (((6))),
wherein the transport path component is made of a flexible resin pipe.
   (((8)))

The powder supply device according to (((6))),
wherein the transport path component has an expansion and contraction portion that is deformable in an expansion and contraction manner, at a part of the transport path component.
   (((9)))

The powder supply device according to any one of (((1))) to (((8))),
wherein the plurality of transport sections are connected in communication between one side of the accommodation section in a longitudinal direction and an opposite side of the supply section in the longitudinal direction.
   (((10)))

The powder supply device according to (((9))),
wherein the plurality of transport sections are disposed symmetrically with respect to a center of an arrangement order of the plurality of processing subjects.
   (((11)))

The powder supply device according to (((10))),
wherein, in an aspect in which the plurality of processing subjects are changeable between a most upstream color and a most downstream color in the processing order,
in a case in which the processing subject of the most upstream color and the processing subject of the most downstream color are changed, the transport section is disposed such that an angle is changeable with a transport drive unit provided on one end side of the transport section as a fulcrum.
   (((12)))

A powder processing system comprising:
a plurality of processing subjects that are arranged in a processing order of a plurality of colors at a predetermined interval; and
a plurality of powder supply devices that supply powder of a plurality of color components to the plurality of processing subjects,
wherein the powder supply device according to any one of (((1))) to (((11))) is used as the powder supply device.
   (((13)))

The powder processing system according to (((12))),
wherein the powder is an imaging material,
the powder supply device includes a developing section as the supply section that performs developing with the imaging material, the accommodation section that accommodates the imaging material, and the transport section that transports the imaging material, and
the processing subject is an image holding section that holds an image produced by the imaging material.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A powder supply device comprising:
a plurality of supply sections that are provided respectively for of a plurality of processing subjects arranged in a processing order of a plurality of colors at a predetermined interval and that supply powder divided into a plurality of color components to each processing subject;
a plurality of accommodation sections that are arranged at an interval wider than an arrangement interval between the plurality of processing subjects and that accommodate the powder divided into the plurality of color components; and
a plurality of transport sections that are respectively connected in communication between the plurality of accommodation sections and the plurality of supply sections and that transport the powder of each color component accommodated in each accommodation section to each supply section,
wherein the plurality of transport sections have a configuration that is shareable at least for the processing subjects of which the processing order is changeable.

2. The powder supply device according to claim 1,
wherein the plurality of processing subjects are changeable between a most upstream color and a most downstream color in the processing order of the plurality of colors.

3. The powder supply device according to claim 2,
wherein the plurality of processing subjects are changeable between colors other than the most upstream color and the most downstream color.

4. The powder supply device according to claim 1,
wherein the plurality of colors include a spot color different from four colors of cyan, magenta, yellow, and black.

5. The powder supply device according to claim 4,
wherein the spot color is clear or white.

6. The powder supply device according to claim 1,
wherein the plurality of transport sections include transport path components that have equal transport path lengths and transport members that transport the powder along the transport path components, for the processing subjects of which the processing order is changeable.

7. The powder supply device according to claim 6,
wherein the transport path component is made of a flexible resin pipe.

8. The powder supply device according to claim 6,
wherein the transport path component has an expansion and contraction portion that is deformable in an expansion and contraction manner, at a part of the transport path component.

9. The powder supply device according to claim 1,
wherein the plurality of transport sections are connected in communication between one side of the accommodation section in a longitudinal direction and an opposite side of the supply section in the longitudinal direction.

10. The powder supply device according to claim 9,
wherein the plurality of transport sections are disposed symmetrically with respect to a center of an arrangement order of the plurality of processing subjects.

11. The powder supply device according to claim 10,
wherein, in an aspect in which the plurality of processing subjects are changeable between a most upstream color and a most downstream color in the processing order,
in a case in which the processing subject of the most upstream color and the processing subject of the most downstream color are changed, the transport section is disposed such that an angle is changeable with a transport drive unit provided on one end side of the transport section as a fulcrum.

12. A powder processing system comprising:
a plurality of processing subjects that are arranged in a processing order of a plurality of colors at a predetermined interval; and
a plurality of powder supply devices that supply powder of a plurality of color components to the plurality of processing subjects,
wherein the powder supply device according to claim 1 is used as the powder supply device.

13. A powder processing system comprising:
a plurality of processing subjects that are arranged in a processing order of a plurality of colors at a predetermined interval; and
a plurality of powder supply devices that supply powder of a plurality of color components to the plurality of processing subjects,
wherein the powder supply device according to claim 2 is used as the powder supply device.

14. A powder processing system comprising:
a plurality of processing subjects that are arranged in a processing order of a plurality of colors at a predetermined interval; and
a plurality of powder supply devices that supply powder of a plurality of color components to the plurality of processing subjects,
wherein the powder supply device according to claim 3 is used as the powder supply device.

15. A powder processing system comprising:
a plurality of processing subjects that are arranged in a processing order of a plurality of colors at a predetermined interval; and
a plurality of powder supply devices that supply powder of a plurality of color components to the plurality of processing subjects,
wherein the powder supply device according to claim 4 is used as the powder supply device.

16. A powder processing system comprising:
a plurality of processing subjects that are arranged in a processing order of a plurality of colors at a predetermined interval; and
a plurality of powder supply devices that supply powder of a plurality of color components to the plurality of processing subjects,
wherein the powder supply device according to claim 5 is used as the powder supply device.

17. A powder processing system comprising:
a plurality of processing subjects that are arranged in a processing order of a plurality of colors at a predetermined interval; and
a plurality of powder supply devices that supply powder of a plurality of color components to the plurality of processing subjects,
wherein the powder supply device according to claim 6 is used as the powder supply device.

18. A powder processing system comprising:
a plurality of processing subjects that are arranged in a processing order of a plurality of colors at a predetermined interval; and
a plurality of powder supply devices that supply powder of a plurality of color components to the plurality of processing subjects,
wherein the powder supply device according to claim 7 is used as the powder supply device.

19. A powder processing system comprising:
a plurality of processing subjects that are arranged in a processing order of a plurality of colors at a predetermined interval; and
a plurality of powder supply devices that supply powder of a plurality of color components to the plurality of processing subjects,
wherein the powder supply device according to claim 8 is used as the powder supply device.

20. The powder processing system according to claim 12,
wherein the powder is an imaging material,
the powder supply device includes a developing section as the supply section that performs developing with the imaging material, the accommodation section that accommodates the imaging material, and the transport section that transports the imaging material, and
the processing subject is an image holding section that holds an image produced by the imaging material.
